(19) United States
(12) Patent Application Publication
(10) Pub. No.: US 2019/0081445 A1
(43) Pub. Date: Mar. 14, 2019

(54) INTERMEDIATE ADAPTER FOR ATTACHING A CONNECTOR UNIT TO AN APPLIANCE, AND POWER SUPPLY KIT

(71) Applicant: FRIWO Gerätebau GmbH, Ostbevern (DE)

(72) Inventors: Thomas Kuhn, Ladbergen (DE); Weihua Jiang, Guangdong (CN)

(21) Appl. No.: 16/125,243

(22) Filed: Sep. 7, 2018

(30) Foreign Application Priority Data
Sep. 8, 2017 (EP) 17 190 196.0

(51) Int. Cl. H01R 31/06; H01R 13/24; H01R 13/629

(52) U.S. Cl. CPC H01R 31/06; H01R 13/629; H01R 13/24

(57) ABSTRACT

An intermediate adapter for attaching a connector unit to an appliance, the intermediate adapter comprising: a base plate having an appliance portion which is connectable to the appliance and comprises at least two first contact elements, and a connector portion which is connectable to the connector unit and has at least two second contact elements; at least two electrically conductive leads interconnecting said first and second contact elements.

### BACKGROUND OF THE INVENTION

The present invention relates to an intermediate adapter for attaching a connector unit to an appliance and to a power supply kit comprising an appliance, at least one detachable connector unit, and the detachable intermediate adaptor.

In conventional exchangeable plug systems, an electrical appliance can be plugged with various country specific connector units to an external network to acquire an operating power thereof. The appliance housing comprises a universal input connectable to a rear profile of the detachable connector unit. As the appliance usually comprises circuits or transformers, the sizes of the appliances tend to be relatively bulky. In order to optimize the used space of the appliance, when being plugged to the external network, a special orientation of the appliance with regard to the plug might be desirable. Therefore, either appliance housings with differently oriented universal inputs have to be manufactured or the prong orientation of the connector unit needs to be adjustable. While appliance housings with differently oriented universal inputs increase the product variety, connector units or appliance housings with means for adjusting the prong orientation tend to be bulky.

Examples for a connector unit with means for a multi directional plug-orientation are known from U.S. Pat. No. 8,933,847 B1, US 2011/0117766, and US 2013/0183854 A1. Examples for an appliance with means for a multi-directional plug orientation are known from US 2008/0064244 A1 and DE 20 2006 001 398 U1.

### SUMMARY OF THE INVENTION

An object underlying the invention is to reduce the product variety of the appliance housings, as for example providing a multi-directional plug orientation. A further object underlying the invention is to maintain flexibility, as for example by providing a universal input connectable to various country specific connector units. Additionally, an object of the present invention is to optimize the space requirements of the appliance with connected connector unit, as for example by reducing the size of the connected connector unit. Furthermore, an object of the present is to provide a simple and economic solution.

According to the present invention, an intermediate adapter is provided, which is adapted for attaching a connector unit to an appliance, and comprises a base plate having an appliance portion which is connectable to the appliance and comprises at least two first contact elements, and a connector portion which is connectable to the connector unit and has at least two second contact elements. At least two electrically conductive leads are interconnecting said first and second contact elements, wherein said first contact elements form a first connection arrangement having a first orientation with respect to a rotation axis of the base plate and said second contact elements form a second connection arrangement having a second orientation with respect to the rotation axis, and the second connection arrangement is oriented at a non-zero angle with respect to the first connection arrangement.

Consequently, the intermediate adapter enables changing a pin orientation of the connector unit, when used to attach the connector unit to the appliance. In more detail, the appliance is preferably a power supply and the connector unit is preferably a flat, two-pole, round-pin domestic AC power plug of the type Europlug. In other words, the intermediate adapter enables to change the orientation of the pins with respect to the appliance by either using the intermediate adapter or by not using the intermediate adapter.

According to an advantageous embodiment, the appliance portion and the connector portion are formed on opposing first and second surfaces of the base plate. Consequently, the intermediate adapter can be manufactured as a flat plate with a low height. Furthermore, the rotation axis is perpendicular to a plane of the base plate extending along the first and second surfaces. Consequently, the space requirement of the intermediate adapter, when attached to the appliance and attached to the connector, is reduced. Preferably, the base plate is manufactured by an injection molding or casting process.

Further, according to another embodiment of this invention, the first contact elements are configured for a sliding electrical connection matching with an engaging seat of the appliance, and the second contact elements are configured for a sliding electrical connection matching with a rear profile of the connector unit. Advantageously, said first contact elements are formed as pads with a sliding ramp configured for guiding a first electrical contact of the appliance, and/or said second contact elements are formed as spring contacts protruding from the base plate, the spring contacts configured for pressing to a mating electrical contact of the connector unit. Such sliding electrical first and second contact elements allow a detachable mounting to the appliance and to the connector unit, which can be easily attached and detached by a user.

According to another embodiment of this invention, the appliance portion comprises at least one first fastening element configured for a sliding mechanical connection with an engaging seat of the appliance, and the connector portion comprises at least one second fastening element configured for a sliding mechanical connection with a rear profile of the connector unit. The first fastening element comprises at least one first guiding rail protruding from the base plate, the guiding rail configured to engage with a first recess at the appliance, and/or the second fastening element comprises at least one second guiding rail protruding from the base plate, the guiding rail configured to engage with a second recess at the connector unit. Such sliding mechanical first and second fastening elements allow a detachable mounting to the appliance and to the connector unit, which can be easily attached and detached by a user. Furthermore, the base plate comprises a dismounting opening configured to receive a tool for dismounting the intermediate adapter from the appliance or the connector unit. The dismounting opening defines a point, where a user can apply a force by a tool such as a screw in order to solve the intermediate from the connector unit or the appliance in a non-destructive manner.

Further, according to another embodiment of this invention, at least one conductive lead comprises at least one opening and the base plate comprises at least one notch that engages the at least one opening so as to lock the conductive lead at a defined position at the base plate. Consequently, at least one conductive lead is attached to the intermediate adapter. Additionally or alternatively, the conductive leads are hot stamped to the base plate. Thus, the conductive lead can be easily connected to the base plate and is securely fixed thereon

According to another embodiment of this invention, at least one conductive lead extends through an opening in the base plate. Further, according to another embodiment, at least one conductive lead is arranged on the appliance portion. Additionally or alternatively, at least one conductive lead and the first and second contact elements connected by said conductive lead are manufactured as a bent metal sheet. Thus, the conductive lead can be easily manufactured.

Further, according to another embodiment of this invention the intermediate adapter further comprises an insulation cap non-detachably connected to the appliance portion covering said conductive leads. Consequently, the conductive leads are at least partly covered by the insulation cap, and thus, safety requirements are easily fulfilled.

The present invention further relates to a power supply kit comprising an appliance, at least one detachable connector unit, and the detachable intermediate adaptor. Advantageously, an engaging seat of the appliance is directly connectable to a rear profile of the at least one connector unit. Additionally or alternatively, the non-zero angle is 90°.

### BRIEF DESCRIPTION OF THE DRAWINGS

The accompanying drawings are incorporated into the specification and form a part of the specification to illustrate several embodiments of the present invention. These drawings, together with the description serve to explain the principles of the invention. The drawings are merely for the purpose of illustrating the preferred and alternative examples of how the invention can be made and used, and are not to be construed as limiting the invention to only the illustrated and described embodiments. Furthermore, several aspects of the embodiments may form—individually or in different combinations—solutions according to the present invention. The following described embodiments thus can be considered either alone or in an arbitrary combination thereof. Further features and advantages will become apparent from the following more particular description of the various embodiments of the invention, as illustrated in the accompanying drawings, in which like references refer to like elements, and wherein:

FIG. 1 is an exploded perspective view of the power supply kit according to the present invention;

FIG. 2 is a schematic perspective view of the power supply kit according to the present invention;

FIG. 3 is a cross-sectional side-view of the power supply kit according to the present invention;

FIG. 4 is a detail IV of FIG. 3;

FIG. 5 is a planar schematic view of the power supply kit according to the present invention;

FIG. 6 is a further planar schematic view of the power supply kit according to the present invention;

FIG. 7 is a further planar schematic view of the power supply kit according to the present invention;

FIG. 8 is a further planar schematic view of the power supply kit according to the present invention;

FIG. 9 is a further planar schematic view of the power supply kit according to the present invention;

FIG. 10 is a further planar schematic view of the power supply kit according to the present invention;

FIG. 11 is an exploded perspective view of an intermediate adapter according to the present invention;

FIG. 12 is an exploded perspective view of an intermediate adapter according to the present invention;

FIG. 13 is a schematic perspective view of a base plate according to the present invention;

FIG. 14 is a further schematic perspective view of a base plate according to the present invention;

FIG. 15 is a sectional view along the line XV-XV of FIG. 17;

FIG. 16 is a schematic planar view of the base plate according to the present invention;

FIG. 17 is a further schematic planar view of the base plate according to the present invention;

FIG. 18 is a further schematic planar view of the base plate according to the present invention;

FIG. 19 is a further schematic planar view of the base plate according to the present invention;

FIG. 20 is a schematic perspective view of a first conductive lead interconnecting a first and second contact element;

FIG. 21 is a schematic planar view of FIG. 20;

FIG. 22 is a further schematic planar view of FIG. 20;

FIG. 23 is a further schematic planar view of FIG. 20;

FIG. 24 is a further schematic planar view of FIG. 20;

FIG. 25 is a further schematic planar view of FIG. 20;

FIG. 26 is a schematic perspective view of a second conductive lead interconnecting a first and second contact element;

FIG. 27 is a schematic planar view of FIG. 26;

FIG. 28 is a further schematic planar view of FIG. 26;

FIG. 29 is a further schematic planar view of FIG. 26;

FIG. 30 is a further schematic planar view of FIG. 26;

FIG. 31 is a further schematic planar view of FIG. 26;

FIG. 32 is a schematic perspective view of an insulation cap according to the present invention;

FIG. 33 is a further schematic perspective view of an insulation cap according to the present invention;

FIG. 34 is a schematic planar view of the insulation cap according to the present invention;

FIG. 35 is a further schematic planar view of the insulation cap according to the present invention;

FIG. 36 is a further schematic planar view of the insulation cap according to the present invention;

FIG. 37 is a sectional view along the line XXXVII-XXXVII of FIG. 38;

FIG. 38 is a further schematic planar view of the insulation cap according to the present invention;

FIG. 39 is a schematic perspective view of a part of the power supply kit according to the present invention.

### DETAILED DESCRIPTION

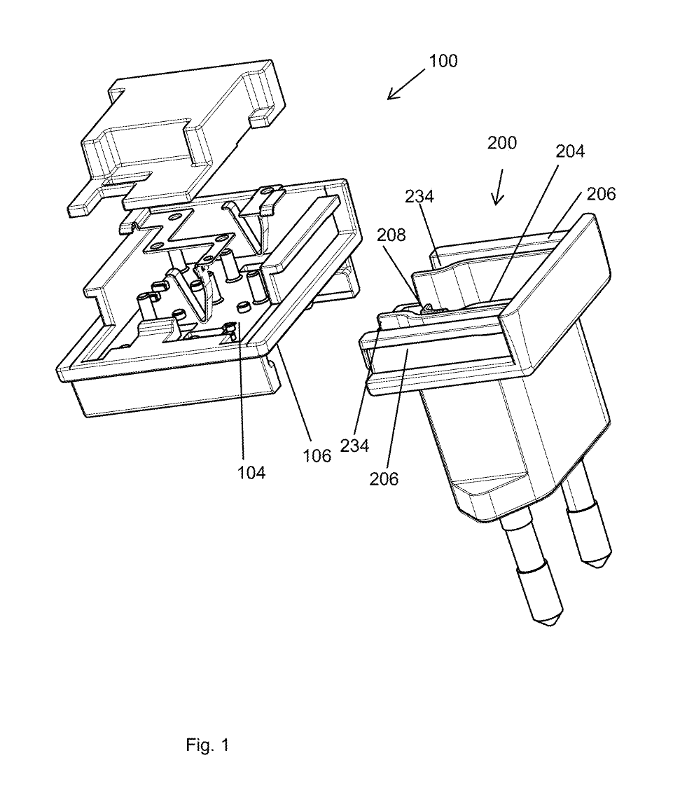

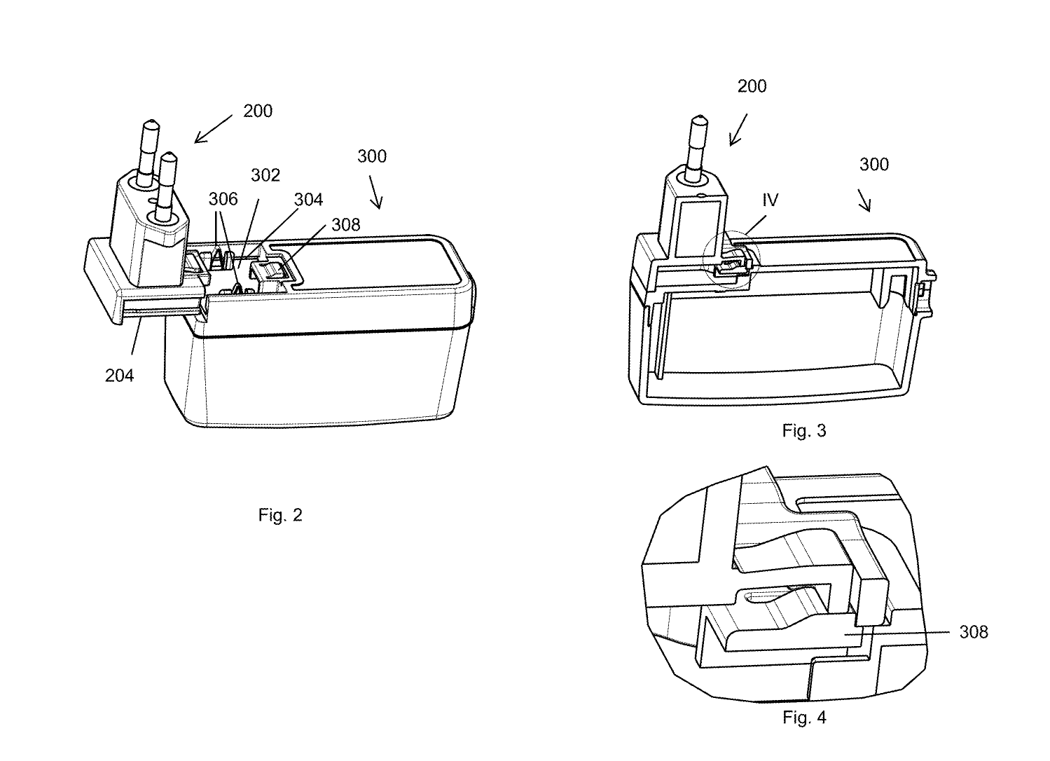

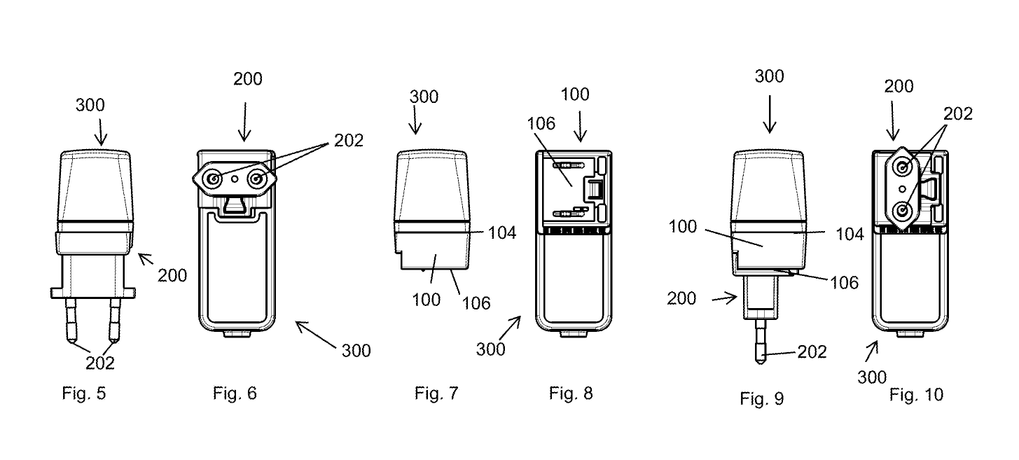

The present invention will now be explained in more detail with reference to the Figures and firstly referring to FIGS. 1 to 10, which show a power supply kit according to a preferred embodiment of the present invention. The power supply kit comprises an appliance 300, at least one detachable connector unit 200, and a detachable intermediate adaptor 100. The intermediate adaptor 100 and the connector unit 200 are each individually connectable to the appliance 300. In more detail, FIG. 1 shows an exploded perspective view of the intermediate adapter 100, which is connectable with the connector unit 200. FIG. 2 shows the connector unit 200, which is connectable to the appliance 300. FIG. 3 shows a cross-section of the connector unit 200 connected to the appliance 300 and FIG. 4 shows a detail thereof. FIGS. 5 to 10 show planar schematic views of the power supply kit according to the present invention.

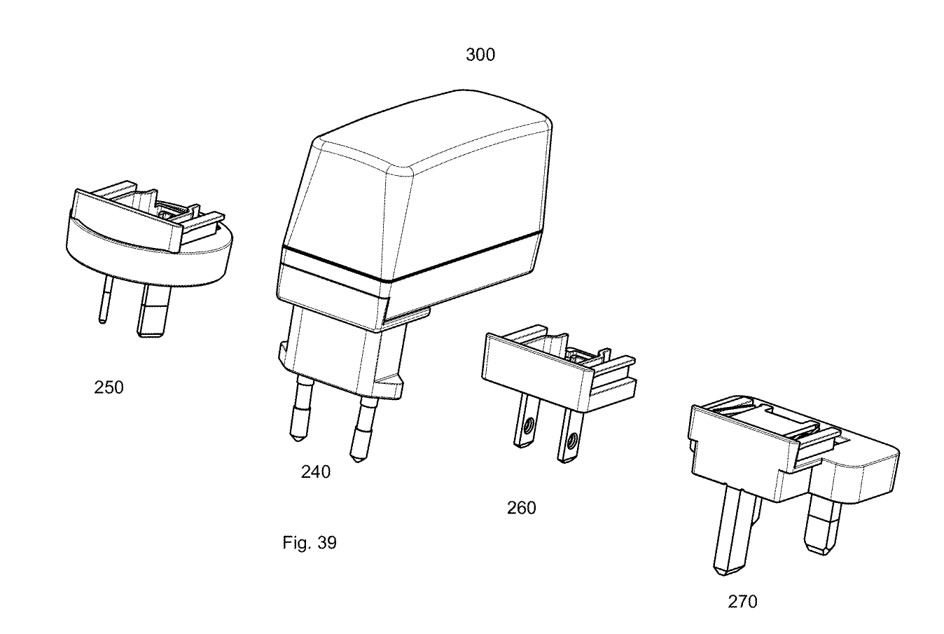

According to one embodiment of the present invention, as shown in FIGS. 2 to 10, the appliance 300 is a power supply to convert a first form of energy received from an external network to a second form of energy supplied to a load. The appliance 300 is connected to the external network by a connector unit 200 with a plug having two pins 202. In particular, the plug is a flat, two-pole, round-pin domestic AC power plug of the type Europlug. However, the invention is not limited to a Europlug with two pins, as will be discussed with reference to FIG. 39. Moreover, the number of pins may be more than two in alternative embodiments. In particular, the number of electrical contacts can be three or four. Furthermore, the appliance is not necessarily a power supply but might be any electrical device that receives energy from an external network.

Further, the power supply kit of the present invention enables to connect the connector unit 200 to the appliance 300 in two attachment configurations. A first attachment configuration is shown in FIGS. 2 to 6. In particular, a rear profile 204 of the connector unit 200 is attached directly, i.e. without the intermediate adapter 100, to an engaging seat 302 of the appliance 300.

A second attachment configuration is shown in FIGS. 9 and 10. In particular, a rear profile 204 of the connector unit 200 is attached indirectly, i.e. with the intermediate adapter 100, to an engaging seat 302 of the appliance 300. In more detail, the rear profile 204 is attached to a connector portion 106 of the intermediate adapter 100. Further, an appliance portion 104 of the intermediate adapter 100 is attached to the engaging seat 302. According to the present invention, the second attachment configuration differs from the first attachment configuration in the orientation of the pins 202 of the connector unit 200 with respect to the appliance 300.

In other words, the assembly kit enables to change the orientation of the pins 202 with respect to the appliance 300 by either using the intermediate adapter 100 or by not using the intermediate adapter 100. Preferably, the orientation of the pins 202 is rotated by 90° by connecting the connector unit 200 with the appliance 300 by using the intermediate adapter 100. However, the present invention is not limited to an intermediate adapter that changes the orientation by an angle of 90°. Any non-zero angle, for example 45°, is also possible.

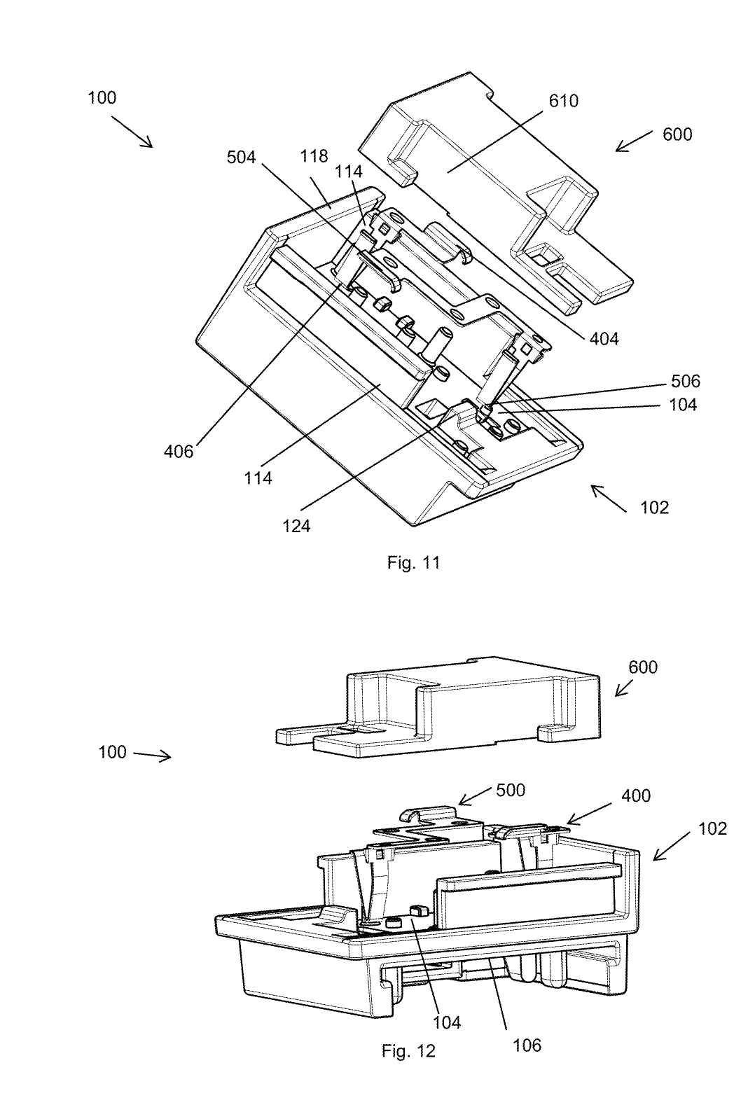

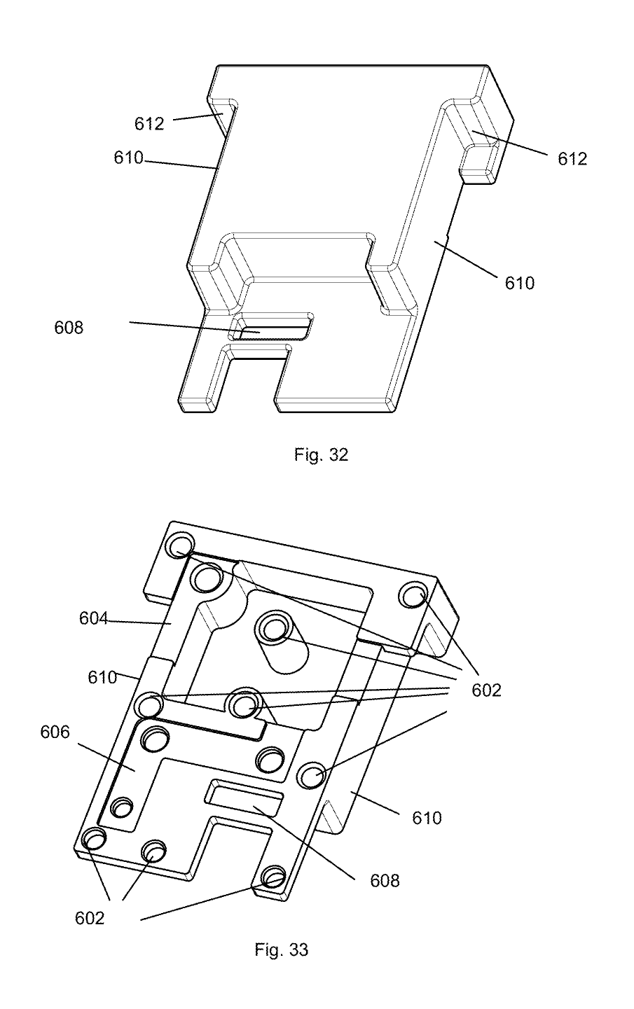

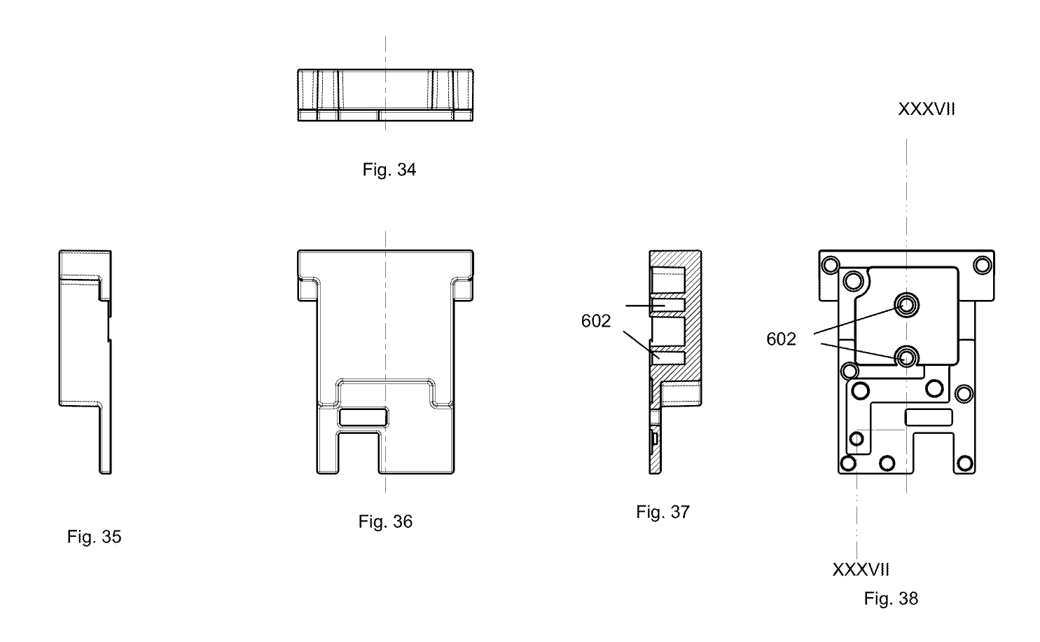

Now, with reference to FIGS. 11 to 38, details of a preferred embodiment of the intermediate adapter 100 for attaching the connector unit 200 to the appliance 300 are described. As best shown in the exploded perspective views of FIGS. 11 and 12, the intermediate adapter 100 comprises a base plate 102, a first electrical connector 400, a second electrical connector 500, and an optional insulation cap 600. The first and second electrical connectors 400 and 500 are fed through openings in the base plate 102 for electrically interconnecting opposing first and second surfaces of the base plate 102. In more detail, an appliance portion 104, which is connectable to the engaging seat 302 of the appliance 300, is formed on the first surface and a connector portion 106, which is connectable to the connector unit 200, is formed on the second surface. Furthermore, the insulation cap 600 is attached to the appliance portion 104 and partly covers the first and second electrical connectors 400 and 500.

The intermediate adapter 100 comprises two arrangement configurations for changing the orientation of the pins 202 of the connector unit 200, when used to attach the connector unit 200 to the appliance 300. Therefore, as best shown in FIG. 11, the appliance portion 104 comprises means for electrically connecting to the engaging seat 302. In more detail, the first and second electrical connectors 400 and 500 comprise two respective first contact elements 404 and 504 forming a first connection arrangement matching two electrical contacts 306 of the engaging seat 302. The first connection arrangement has a first orientation with respect to a rotation axis of the base plate 102. According to the present embodiment, the base plate 102 comprises a rotation axis perpendicular to a plane of the base plate 102 extending along the first and second surfaces. Preferably, the rotation axis is located at a central portion of the base plate 102.

Further, as best shown in FIGS. 8, 11, and 12, the connector portion 106 comprises means for electrically connecting to the rear profile 204 of the connector unit 200. In more detail, the first and second electrical connector 400 and 500 comprise two respective second contact elements 406 and 506 forming a second connection arrangement matching two electrical contacts of the rear profile 204, which are not shown in the drawings. The second connection arrangement has a second orientation with respect to the rotation axis of the base plate 102. In particular, the second connection arrangement is oriented at a non-zero angle with respect to the first connection arrangement. According to the present invention, the connection arrangement at the connector portion 106 is rotated with respect to a connection arrangement of the engaging seat 302 when the intermediate adapter 100 is attached to the appliance 300. According to the one embodiment, as shown for example in FIGS. 5 to 10, the second connection arrangement is oriented an angle of 90° with respect to the first connection arrangement. However, the present invention is not limited to a non-zero angle of 90°.

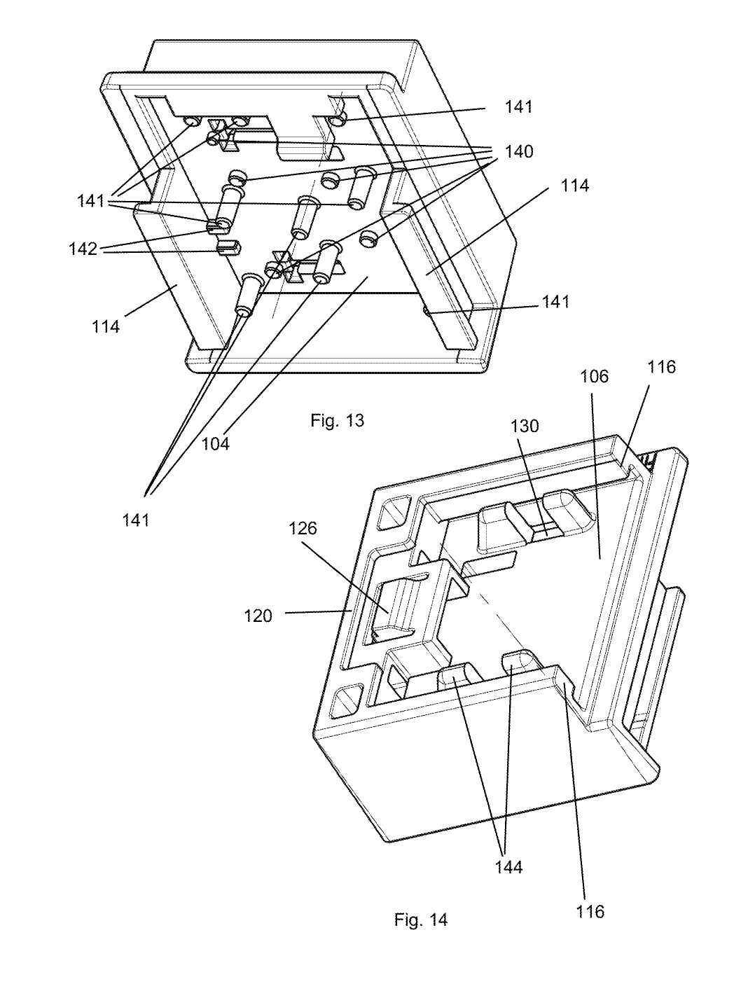

Now, with reference to FIGS. 13 to 19, the base plate 102 of the intermediate adapter is described. Further details of the base plate 102 are described below. The base plate 102 comprises elements for attaching and locking the electrical connectors 400 and 500. Furthermore, the base plate 102 comprises elements for connecting the insulation cap 600 to the base plate. Moreover, the base plate 102 comprises elements for the detachable connection of the intermediate adapter 100 with the appliance 300 and the connector unit 200. According to one embodiment, the base plate 102 is manufactured from an insulating material such as a polymer and preferably from a thermoplastic. Furthermore, the base plate 102 is preferably manufactured as a single piece by a process such as injection molding or casting. However, the present invention is not limited to such molding process as the base plate 102 can be also manufactured, for example, by a printing, sintering, or milling process. Furthermore, the present invention is not limited that the base plate is manufactured as a single piece, as for example individual pieces can be glued to manufacture the base plate.

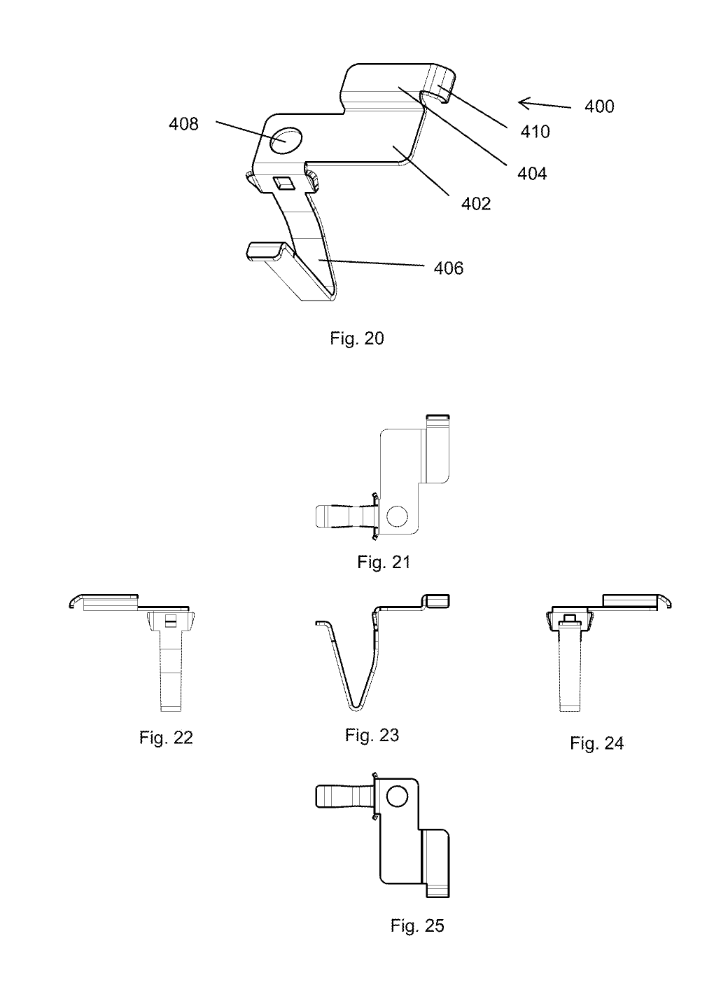

Now, with reference to FIGS. 20 to 25, the first electrical connector 400 according to a preferred embodiment is described in detail. A first contact element 404 is formed at a first end of the first electrical connector 400 and a second contact element 406 is formed at a second end of the electrical connector 400. A first conductive lead 402 is interconnecting the first and second ends 404 and 406. The first conductive lead 402 comprises an opening 408 for engaging with a notch formed at the base plate 102 so as to lock the conductive lead 402 at a defined position at the base plate 102. The first contact element 404 is formed as a pad with a sliding ramp 410 configured for guiding the first electrical contact of the appliance 306. For example, the pad has curved edges so as to smoothly receive the first electrical contact of the appliance 306. Furthermore, the second contact element 406 is formed as a spring contact configured for pressing to a matching electrical contact of the connector unit 200. Preferably, the first contact element 400, and thus the spring contact element 406, is manufactured as a single piece by bending a metal sheet. Further, the spring contact according to one embodiment is configured to be clamped by a feed through opening 130 of the base plate 102 so as to lock the spring contact 406 at a defined position at the base plate 102.

However, for a person skilled in the art is clear that the present invention is not limited to different first and second contact elements or a first contact element manufactured as a single piece, as alternatively the first and second contact element can be shaped similarly and additionally or alternatively can be, for example, soldered to the first conductive lead.

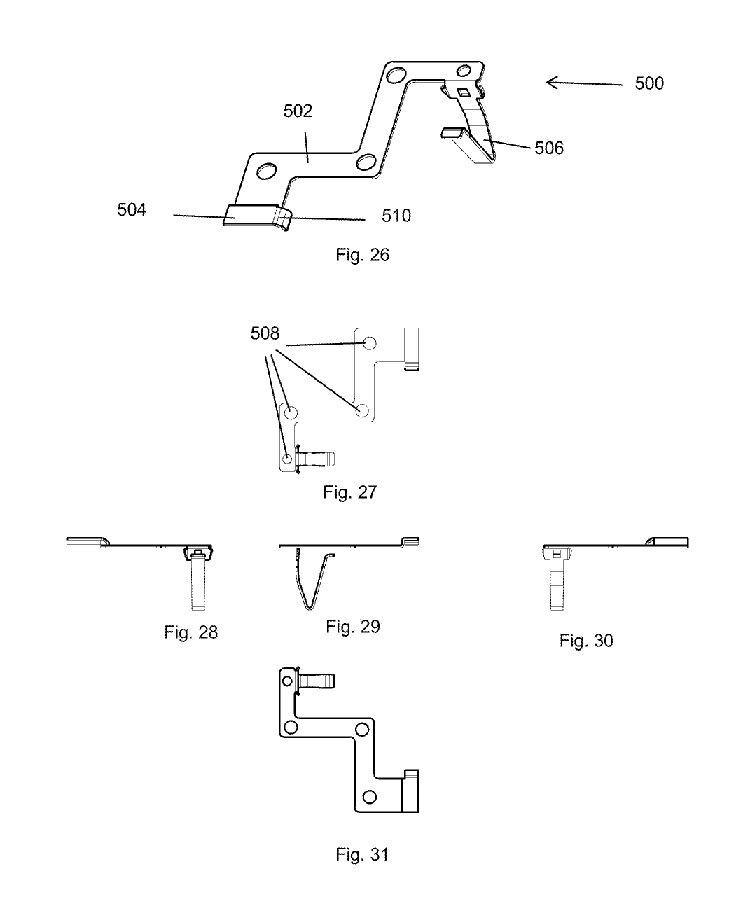

Now, with reference to FIGS. 26 to 31, the similar second electrical connector 500 according to a preferred embodiment is similarly described in detail. A first contact element 504 is formed at a first end of the second electrical connector 500 and a second contact element 506 is formed at a second end of the electrical connecter 500. A second conductive lead 502 is interconnecting the first and second ends 504 and 506. The second conductive lead 502 comprises four openings 508 for engaging with four notches formed at the base plate 102 so as to lock the conductive lead 502 at a defined position at the base plate 102. The first contact element 504 is formed as a pad with a sliding ramp 510 configured for guiding the first electrical contact of the appliance 306. For example, the pad has curved edges so as to smoothly receive the first electrical contact of the appliance 306. Furthermore, the second contact element 506 is formed as a spring contact configured for pressing to a matching electrical contact of the connector unit 200. Preferably, the second contact element 500, and thus the spring contact element 506, is manufactured as a single piece by bending a metal sheet. Further, the spring contact according to one embodiment is configured to be clamped by the feed through opening 130 of the base plate 102 so as to lock the spring contact 506 at a defined position at the base plate 102. However, for a person skilled in the art is clear that the present invention is not limited to different first and second contact elements or a first contact element manufactured as a single piece, as alternatively the first and second contact element can be shaped similarly and additionally or alternatively can be, for example, soldered to the first conductive lead.

As best shown in FIGS. 21 and 27, the first and second electrical connectors 400 and 500 differ in the length of the first and second conductive lead 402 and 502. In particular, the first conductive lead 402 is shorter compared to the second conductive lead 502. This different length of the conductive leads enables that the second connection arrangement is oriented at a non-zero angle with respect to the first connection arrangement. However, the present invention is not limited that the conductive leads 402 and 502 have a different length or a different shape as, for example, circle segments enable similarly shaped conductive leads.

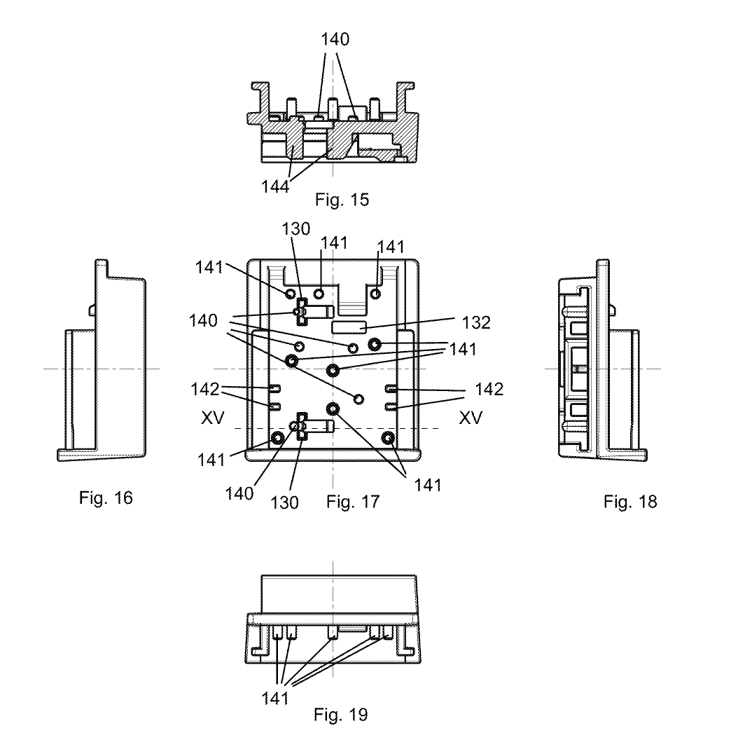

Now, with reference to FIGS. 13 to 19, the elements of the base plate 102 for attaching and locking the electrical connectors 400 and 500 are described in detail. As best shown in FIGS. 13, 15, and 17, the base plate 102 comprises at the appliance portion 104 cylindrical notches 140 protruding from the base plate 102 in the direction of the rotation axis for engaging with the openings 408 and 508 of the first and second electrical connector 400 and 500. Furthermore, the appliance portion 104 comprises rectangular spacers 142 protruding from the base plate 102 in the direction of the rotation axis for positioning and fixing the pads 404 and 504 of the first and second electrical connector 400 and 500. As best shown in FIGS. 14 and 15, the base plate 102 comprises at the connector portion 106 clamps 144 protruding from the base plate 102 in a direction of the rotation axis for clamping the spring contacts 406 and 506 so as to lock the spring contacts at defined positions at the base plate 102. Furthermore, the clamps 144 protect the spring contacts 406 and 506, for example, when connecting the intermediate adapter 100 to the connector unit 200. For a person skilled in the art is clear that the present invention is not limited to the configuration of the elements for connecting to the first and second electrical connectors 400 and 500 of the present embodiment. For example, all elements for attaching and locking the differently shaped electrical connectors 400 and 500 can be arranged at both, the appliance portion 104 and the connector portion 106.

Further, the electrical connector 400 and 500, and in particular the first and second conductive leads 402 and 502, according to one embodiment are non-detachably connected to the base plate 102. For example, the first and second conductive leads 402 and 502 are hot stamped to the base plate 102. However, the present invention is not limited to a hot stamping of the conductive leads 402 and 502 to the base plate 102. For example, the first and second conductive leads 402 and 502 can be non-detachably connected to the base plate 102 by a gluing process, an over-molding process, or the like.

Now, with reference to FIGS. 13, 17, and 32 to 38, the insulating cap 600 and the connection of the insulating cap 600 to the base plate 102 is described in detail. The insulation cap 600 is configured for a non-detachable connection to the appliance portion 104 in order to cover the conductive leads 402 and 502. Thus, the insulating cap 600 enables to fulfill security requirements as insulating the open conductive leads. Preferably, the insulation cap 600 comprises at a surface connecting to the appliance portion 104 cylindrical recesses 602 for engaging with second notches 141 protruding from the base plate 102 in a direction of the rotation axis so as to lock the insulating cap 600 at a defined position at the base plate 102. Furthermore, the insulation cap 600 comprises at the surface connecting to the appliance portion 104 a first conductive lead recesses 604 and a second conductive lead recess 606 for engaging with the respective first conductive lead 402 and the second conductive lead 502, the latter are connected non-detachably to the base plate 102. Furthermore, the insulating cap 600 comprises a second dismounting opening 608 configured to receive a tool for dismounting the intermediate adapter 100 from the appliance 300 or the connector unit 200, when the insulating cap 600 is non-detachably connected to the base plate 102. For a person skilled in the art is clear that the present invention is not limited to an insulation cap 600 for insulating the open conductive leads 402 and 502 at the appliance portion 104. For example, the insulation cap may be non-detachable connected to the connector portion 106 for covering conductive leads arranged at the connector portion 106. Furthermore, the present invention is not limited to an insulating cap that covers the conductive leads 402 and 502 as, for example, the first and second conductive leads 402 and 502 can be isolated by over-molding same by the base plate 102.

Now, with reference to FIGS. 11 to 19, elements to detachably connect the intermediate adapter 100 with the appliance 300 and the connector unit 200 are described. Additionally, with reference to FIGS. 1 to 4, elements at the appliance 300 and the connector unit 200 for engaging with the intermediate adapter 100 are described. Preferably, the appliance 300 comprises at the engaging seat 302 elements for mechanically and electrically connecting with the appliance portion 104 of the intermediate adapter 100 and the connector unit 200 comprises at the rear profile 204 elements for mechanically and electrically connection with connector portion 106 of the intermediate adapter 100 or the engaging seat 302. Preferably, the intermediate adapter 100 is received by the appliance 300 and the connector unit 200 in a direction perpendicular to the rotation axis.

In more detail, the appliance portion 104 comprises two first fastening elements 114 configured for a sliding mechanical connection with the engaging seat 302 of the appliance 300. As best shown in FIG. 13, the appliance portion 104 comprises two first guiding rails 114 protruding from the base plate 102 in a direction of the rotation axis. The two first guiding rails 114 are arranged on opposing first and third edges of the base plate 102 facing each other. As best shown in FIG. 2, the first guiding rails 114 are configured to engage with two first recesses 304 of the appliance 300. The two first recesses 304 forming partly two opposing walls of the engaging seat 302. However, the present invention is not limited to two first fastening elements configured for a sliding mechanical connection. For example, the appliance portion 104 can be detachably connected to the engaging seat 302 by applying a magnetic force, using a detachable screw or the like.

Similarly, the connector portion 106 comprises two second fastening elements 116 configured for a sliding mechanical connection with the rear profile 204 of the connector unit 200. As best shown in FIG. 14, the connector portion 106 comprises two second guiding rails 116 protruding from the base plate 102 in a direction of the rotation axis. The two second guiding rails 114 are arranged at opposing second and fourth edges of the base plate 102 facing each other. As best shown in FIG. 1, the second guiding rails 116 are configured to engage with two second recesses 206 of the connector unit 200. The two second recesses 206 forming partly two opposing walls of the rear profile 204. However, the present invention is not limited to two second fastening elements configured for a sliding mechanical connection. For example, the connector portion 106 can be detachable connected to the rear profile 204 by applying a magnetic force, using a detachable screw or the like.

According to a preferred embodiment, the first and second fastening elements 114 and 116 are arranged on opposing first and second surfaces of the base plate 102. Furthermore, the second and fourth edges of the base plate 102 are oriented at the non-zero angle with respect to the first and third edges of the base plate 102. In particular, this non-zero angle is the same non-zero angle as included between the first connection arrangement and the second connection arrangement. Preferably, the first to fourth edges of the base plate 102 form a rectangle. However, the present invention is not limited to a rectangular shape of the intermediate adapter 100 as, for example, a circular, elliptical, or polygonal shapes of the intermediate adapter 100 are also possible.

Furthermore, the appliance portion 104 comprises a first back wall 118 protruding from the base plate 102 in a direction of the rotation axis arranged at the second edge of the base plate 102 interconnecting said two first fastening elements 114. Similarly, the connector portion 106 comprises a second back wall 120 protruding from the base plate 102 in a direction of the rotation axis arranged at the third edge of the base plate 102 interconnecting said two second fastening element 116. Thus, when the intermediate adapter 100 is mounted to the connector unit 200 or the appliance 300, the first and second back walls 118 and 120 protect the mounted power supply kit against liquid and dust ingression. Furthermore, the first and second back walls 118 and 120 serve as fixed-limit stop in order to position the intermediate adapter 100 at a defined position at the engaging seat 302 and the rear profile 204.

Moreover, the appliance portion 104 comprises a first locking element 124 configured for positioning and locking the intermediate adapter 100 at a defined position of the engaging seat 302. As best shown in FIG. 11, the first locking element 124 protrudes from the base plate 102 in a direction of the rotation axis. The first locking element 124 is arranged close to the fourth edge of the base plate 102. As best shown in FIGS. 2 to 4, the first locking element 124 is configured to snap lock with a first snap lock element 308 arranged at the engaging seat 302.

Similarly, the connector portion 106 comprises a second locking element 126 configured for positioning and locking the intermediate adapter 100 at a defined position with respect to the rear profile 204. As best shown in FIG. 14, the second locking element 126 protrudes from the base plate 102 in a direction of the rotation axis. The second locking element 126 is arranged close to the first edge of the base plate 102. As best shown in FIG. 1, the second locking element 126 is configured to snap lock with a second snap lock element 208 arranged at the rear profile.

Moreover, the intermediate adapter 100 comprises two first receiving channels 134 configured for housing the first contact elements 404 and 504 and configured for guiding the electrical contacts of the appliance 306, when the intermediate adapter 100 is connected to the appliance. Furthermore, the first receiving channels 134 enable to fulfill security requirements as these first connection channels 134 prevent a user for touching the first contact elements 404 and 504. Each first receiving channel 134 is formed by one of the first guiding rails 114 of the appliance portion 104, by a first channel wall 610 of the insulating cap 600 and a back wall 612 of the insulating cap 600. In more detail, as best shown in FIGS. 11, 32, and 33, the insulation cap 600, when mounted to the appliance portion 104, comprises two first channel walls 610, which are facing the guiding rails 114 and extending towards the base plate 102 from a surface of the insulation cap 600 in a direction of the rotation axis. Furthermore, the insulation cap 600 comprises two first back walls 612, interconnecting the guiding rails 114 and the first channel walls 610. The first back walls 612 are extending from the surface of the insulation cap 600 towards the base plate 102 in a direction of the rotation axis. However, the present invention is not limited to first receiving channels formed by connecting the insulation cap 600 to the appliance portion 104. As for example shown in FIG. 1, the rear profile 204 of the connector unit 200 comprises two second receiving channels 234, which are formed as integral part of the connector unit 200 by a process such as injection molding. These second receiving channels 234 have similar dimensions as the first receiving channels 134. For safety reasons it is preferable that the first and second receiving channels 134 have a minimal depth of 5.5 mm and a maximal width of 2.4 mm, according to standards DIN VDE 0620-1 [DIN VDE 0620-1:2016-01 Plugs and socket-outlets for household and similar purposes—Part 1: General requirements on fixed socket-outlets. Beuth-Verlag, Berlin], DIN VDE 0620-101 [DIN VDE 0620-101:1992-05 Plugs and socket-outlets up to 400 V 25 A; flat non-wirable two pole plugs, 2.5 A 250 V, with cord, for the connection of class-II-equipment for household and similar purposes; german version EN 50075:1990. Beuth-Verlag, Berlin], EN 50075:1990 [OEVE IG/EN 50075/1990:1992-02-25 Flat non-wirable two-pole plugs, 2.5 A 250 V, with cord, for the connection of class-II-equipment for household and similar purposes. Beuth-Verlag, Berlin], and IEC60884-1:2002 A2:2013 [IEC 60884-1:2002+AMD1:2006+AMD2:2013 CSV (Consolidated Version) Plugs and socket-outlets for household and similar purposes—Part 1: General requirements. VDE-Verlag, Berlin].

Furthermore, the base plate 102 comprises a dismounting opening 132 configured to receive a tool for dismounting the intermediate adapter 100, when mounted to the appliance 300, or for dismounting the intermediate adapter 100, when mounted to the connector unit 200. As best shown in FIG. 17, the dismounting opening 132 is located in the near of the first and second edges of the base plate 102 connecting the appliance portion 104 and the connector portion 106. Additionally, the second dismounting opening 608 of the insulation cap 600 covers the dismounting opening 132, when the insulation cap 600 is mounted to the base plate 102. Preferably, the dismounting opening 132 and the second dismounting opening 608 have an elliptic shape so as to receive a slot screwdriver.

Now, with reference to FIG. 39, various types of connector units 200 connectable to the appliance 300 are shown. Although not shown, these various types of connector units 200 are also connectable to the intermediate adapter 100. Shown are: a Europlug 240, an Australian socket 250, a USA socket 260, and a UK socket 270. However, the present invention is not limited to these four country sockets. According to the present invention is that each user specific connector unit 200 with a rear profile connectable to the appliance 300 can be also connected to the intermediate adapter 100.

Reference Numerals

| Reference Numeral | Description |
|---|---|
| 100 | intermediate adaptor |
| 102 | base plate |
| 104 | appliance portion |
| 106 | connector portion |
| 114 | first fastening element |
| 116 | second fastening element |
| 118 | first back wall |
| 120 | second back wall |
| 124 | first locking element |
| 126 | second locking element |
| 130 | feed through opening |
| 132 | dismounting opening |
| 134 | first connection channel |
| 140 | notch |
| 141 | second notch |
| 142 | spacer |
| 144 | clamp |
| 200 | connector unit |
| 202 | pin |
| 204 | rear profile |
| 206 | second recess |
| 208 | second snap lock element |
| 234 | second receiving channel |
| 240 | Europlug |
| 250 | Australian socket |
| 260 | USA socket |
| 270 | UK socket |
| 300 | appliance |
| 302 | engaging seat |
| 304 | first recess |
| 306 | electrical contacts of the appliance |
| 308 | first snap lock element |
| 400 | first electrical connector |
| 402 | first conductive lead |
| 404 | first contact element |
| 406 | second contact element |
| 408 | opening |
| 410 | sliding ramp |
| 500 | second electrical connector |
| 502 | second conductive lead |
| 504 | first contact element |
| 506 | second contact element |
| 508 | opening |
| 510 | sliding ramp |
| 600 | insulation cap |
| 602 | second notches |
| 604 | first conductive lead recesses |
| 606 | second conductive lead recess |
| 608 | second dismounting opening |
| 610 | first channel wall |
| 612 | first back wall |

1. An intermediate adapter (100) for attaching a connector unit (200) to an appliance (300), the intermediate adapter comprising:
a base plate (102) having
an appliance portion (104) which is connectable to the appliance (300) and comprises at least two first contact elements (404, 504), and
a connector portion (106) which is connectable to the connector unit (200) and has at least two second contact elements (406, 506);
at least two electrically conductive leads (402, 502) interconnecting said first and second contact elements;
wherein said first contact elements (404, 504) form a first connection arrangement having a first orientation with respect to a rotation axis of the base plate (102) and said second contact elements (406, 506) form a second connection arrangement having a second orientation with respect to the rotation axis, and
the second connection arrangement is oriented at a non-zero angle with respect to the first connection arrangement.

2. The intermediate adapter according to claim 1, wherein
the appliance portion (104) and the connector portion (106) are formed on opposing first and second surfaces of the base plate (102) and
the rotation axis is perpendicular to a plane of the base plate (102) extending along the first and second surfaces.

3. The intermediate adapter according to claim 1, wherein
the first contact elements (404, 504) are configured for a sliding electrical connection matching with an engaging seat (302) of the appliance (300), and
the second contact elements (406, 506) are configured for a sliding electrical connection matching with a rear profile (204) of the connector unit (200).

4. The intermediate adapter according to claim 1, wherein
said first contact elements (404, 504) are formed as pads with a sliding ramp configured for guiding a first electrical contact of the appliance (306), and/or
said second contact elements (406, 506) are formed as spring contacts protruding from the base plate (102), the spring contacts configured for pressing to a matching electrical contact of the connector unit.

5. The intermediate adapter according to claim 1, wherein
the appliance portion (104) comprises at least one first fastening element (114) configured for a sliding mechanical connection with an engaging seat (302) of the appliance (300), and
the connector portion (106) comprises at least one second fastening element (116) configured for a sliding mechanical connection with a rear profile (204) of the connector unit (200).

6. The intermediate adapter according to claim 1, wherein
the first fastening element (114) comprises at least one first guiding rail protruding from the base plate (102), the guiding rail configured to engage with a first recess (304) at the appliance (300), and/or
the second fastening (116) element comprises at least one second guiding rail protruding from the base plate (102), the guiding rail configured to engage with a second recess (206) at the connector unit (200).

7. The intermediate adapter according to claim 1, wherein the base plate (102) comprises a dismounting opening (132) configured to receive a tool for dismounting the intermediate adapter (100) from the appliance (300) or the connector unit (200).

8. The intermediate adapter according to claim 1, wherein at least one conductive lead (402, 502) comprises at least one opening (408, 508) and the base plate (102) comprises at least one notch (140) that engages the at least one opening (408, 508) so as to lock the conductive lead (402, 502) at a defined position at the base plate (102).

9. The intermediate adapter according to claim 1, wherein said conductive leads (402, 502) are hot stamped to the base plate (102).

10. The intermediate adapter according to claim 1, wherein at least one conductive lead (402, 502) is fed through a feed through opening (130) in the base plate (102).

11. The intermediate adapter according to claim 1, wherein at least one conductive lead (402, 502) is arranged on the appliance portion (104).

12. The intermediate adapter according to claim 1, wherein at least one conductive lead (402, 502) and the first and second contact elements connected by said conductive lead are manufactured as a bent metal sheet.

13. The intermediate adapter according to claim 1, further comprising an insulation cap (600) non-detachably connected to the appliance portion (104) covering said conductive leads.

14. A power supply kit comprising an appliance (300), at least one detachable connector unit (200), and a detachable intermediate adaptor (100) according to claim 1.

15. A power supply kit according to claim 14, wherein
an engaging seat (302) of the appliance (300) is directly connectable to a rear profile (204) of the at least one connector unit (200), and/or
the non-zero angle is 90°.
